(19) United States
(12) Patent Application Publication
(10) Pub. No.: US 2017/0059959 A1
(43) Pub. Date: Mar. 2, 2017

(54) LIQUID CRYSTAL CELL METHOD FOR MANUFACTURING SAME AND DISPLAY DEVICE

(71) Applicants: Boe Technology Group Co., Ltd., Beijing (CN); Beijing Boe Optoelectronics Technology Co., Ltd., Beijing (CN)

(72) Inventors: Xiaojuan Wu, Beijing (CN); Hongliang Yuan, Beijing (CN)

(21) Appl. No.: 14/913,308

(22) PCT Filed: Aug. 21, 2015
(86) PCT No.: PCT/CN2015/087774

§ 371 Date: Feb. 19, 2016

(30) Foreign Application Priority Data
Apr. 16, 2015 (CN) 201510182183.8

(51) Int. Cl. G02F 1/29; G02B 27/22; G02F 1/135

(52) U.S. Cl. CPC G02F 1/292; G02F 1/135; G02B 27/2214; G02F 2202/36; G02F 2202/16; G02F 2203/24

(57) ABSTRACT

The present disclosure relates to the field of display technologies, and in particular to a liquid crystal cell, a method for manufacture the liquid crystal cell, and a display device. The liquid crystal cell comprises two substrates and a liquid crystal layer, the liquid crystal layer disposed between the two substrates and provided with ferriferous oxide nano-particles. A viscosity coefficient of liquid crystals is substantially reduced by adding into the liquid crystal layer the ferriferous oxide nano-particles which may produce heat under a voltage.

### RELATED APPLICATIONS

The present application is the U.S. national phase entry of PCT/CN2015/087774 with an International filing date of Aug. 21, 2015, which claims the benefit of Chinese Application No. 201510182183.8, filed Apr. 16, 2015, the entire disclosures of which are incorporated herein by reference.

### TECHNICAL FIELD

The present disclosure relates to the field of display technologies, and in particular to a liquid crystal cell, a method for manufacturing same, and a display device.

### BACKGROUND

Liquid crystal displays, such as display screens of mobile phones, Note Books, GPS devices and LCD TVs, have gained growing popularity in modern life. With the advance of scientific technologies, conventional displays can no longer meet people's requirements toward display quality, as they can only display planar images. 3D displays have been studied extensively in recent years, because such displays render images more stereoscopic and vivid, and not limited to the surface of the screens, which brings audiences an immersive experience.

3D display devices may be categorized into two types: a glasses type and an autostereoscopic type. When using the glasses type 3D display devices for watching, one has to wear particular 3D glasses, otherwise he/she would see a blurred image on the 3D display device. In terms of the autostereoscopic 3D displays, they have found extensive applications due to advantages such as not requiring glasses and convenient for use.

Autostereoscopic 3D liquid crystal displays may be classified as those having either liquid crystal optical gratings or lenses, both of which may achieve switching between a 2D and a 3D mode by applying a voltage or not to liquid crystal electrodes and may allow a human's left eye and right eye to receive a proper image respectively by controlling the magnitude of the applied voltage. However, during the dynamic switching of the applied voltage, the liquid crystal film in the autostereoscopic 3D liquid display as described above may be less responsive due to a relatively large viscosity coefficient of the liquid crystals, thereby giving rise to significant optical changes, such as 3D crosstalk and image dithering, which will be perceived by audiences in a viewing activity.

### SUMMARY

It is an object of the present disclosure to provide a liquid crystal cell, a method for manufacturing the liquid crystal cell, and a display device, which may overcome the above problems resulting from a large viscosity coefficient of the liquid crystal.

In accordance with an aspect of the present disclosure, a liquid crystal cell is provided comprising two substrates and a liquid crystal layer disposed between the two substrates and provided with ferriferous oxide nano-particles.

In an embodiment, a mass percent of the ferriferous oxide nano-particles in the liquid crystal layer is 1-10%.

In an embodiment, the liquid crystal cell is one of a liquid crystal optical grating, a liquid crystal lens, and a liquid crystal prism.

In an embodiment, the liquid crystal cell further comprises a photosensitive coupling component for detection of a change in a position of an observer's eyes.

In an embodiment, the ferriferous oxide nano-particles are ferriferous oxide nano-particles modified with oleic acid.

In an embodiment, a mass percent of the ferriferous oxide nano-particles modified with oleic acid in the liquid crystal layer is 1-15%. In accordance with another aspect of the present disclosure, a display device is provided comprising a display panel and a liquid crystal cell as described above, the liquid crystal cell provided at a light exiting side of the display panel.

In an embodiment, the display device is operable to work in either a 2D display mode or a 3D display mode. The 2D and 3D display modes are switched by controlling a deflection of liquid crystals in the liquid crystal layer of the liquid crystal cell.

In accordance with yet another aspect, a method for manufacturing the liquid crystal cell is provided comprising providing two substrates and forming a liquid crystal layer between the two substrates, the liquid crystal layer added with ferriferous oxide nano-particles.

The present disclosure is based on an idea that the viscosity coefficient of liquid crystals can be substantially decreased by the addition of ferriferous oxide nano-particles which may produce heat under a voltage into the liquid crystal layer of the liquid crystal cell, thus boosting the response speed of the liquid crystal cell.

### BRIEF DESCRIPTION OF THE DRAWINGS

FIG. 1 shows a structural schematic diagram of a liquid crystal cell in accordance with an embodiment of the present disclosure;

FIG. 2a shows a schematic diagram of a state in which human eyes are looking straight to a screen in an embodiment where the liquid crystal cell is a liquid crystal optical grating;

FIG. 2b shows a schematic diagram of a state in which human eyes are watching a screen from a displaced position in an embodiment where the liquid crystal cell is a liquid crystal optical grating;

FIG. 3a shows a schematic diagram of a state in which human eyes are watching a screen at a certain angle in an embodiment where the liquid crystal cell is a liquid crystal lens;

FIG. 3b shows a schematic diagram of a state in which human eyes are watching a screen at another angle in an embodiment where the liquid crystal cell is a liquid crystal lens;

FIG. 4 shows a variation curve of the required amount of time for a temperature of a liquid crystal layer added with 1 wt % ferriferous oxide nano-particles increasing by 2° C. versus a frequency of a voltage having a fixed amplitude of 4.0 V;

FIG. 5 shows a variation curve of the required amount of time for a temperature of a liquid crystal layer added with 1 wt % ferriferous oxide nano-particles increasing by 2° C. versus a magnitude of an applied voltage having a fixed frequency of 900 KHz; and

FIG. 6 shows a flow chart of a method for manufacturing a liquid crystal cell in accordance with an embodiment of the present disclosure.

### DETAILED DESCRIPTION

Embodiments of the present disclosure will be further described in detail below in connection with the accompanying drawings. The following embodiments are intended to be illustrative of the present disclosure, and not to limit the scope of the present disclosure.

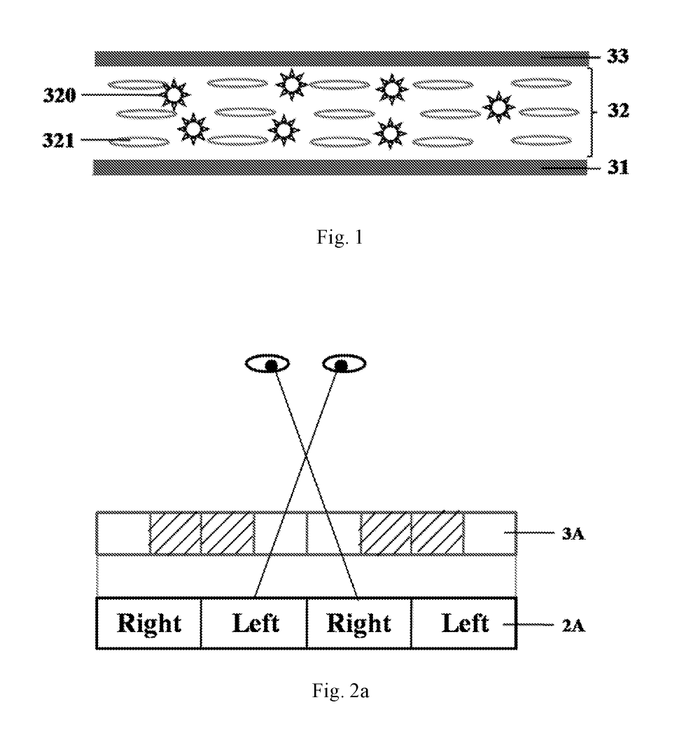

FIG. 1 shows a structural schematic diagram of a liquid crystal cell in accordance with an embodiment of the present disclosure. As shown in FIG. 1, the liquid crystal cell comprises two substrates 31 and 33, and a liquid crystal layer 32 disposed between the two substrates. The liquid crystal layer 32 is provided with ferriferous oxide nano-particles 320. Proper images may be received by a human's left eye and right eye, respectively, by controlling a magnitude of a voltage applied to the liquid crystal layer 32. In an application of an autostereoscopic 3D liquid crystal display device, a 2D display mode and a 3D display mode can be switched by controlling a deflection of liquid crystals in the liquid crystal layer 32. In particular, the liquid crystal layer 32 is added with ferriferous oxide nano-particles 320. Under a high-frequency electric field, the ferriferous oxide nano-particles 320 have a heating effect, i.e., converting electromagnetic energy into heat. In this way, under the voltage, the ferriferous oxide nano-particles 320 increase the temperature in the liquid crystal layer 32, resulting in a reduction of the viscosity coefficient of liquid crystals 321 in the liquid crystal layer 32, and hence the response time of liquid crystals 321. Thus, the response speed of the liquid crystal cell is boosted.

In practice, the mass percent of the ferriferous oxide nano-particles 320 in the liquid crystal layer 32 may be 1-10%, so as to better make use of the heating effect of the ferriferous oxide nano-particles 320 in the liquid crystal layer 32. If the mass percent of the ferriferous oxide nano-particles 320 in the liquid crystal layer 32 is too low, the heating effect of the ferriferous oxide nano-particles 320 cannot be exploited, such that the viscosity coefficient of the liquid crystals cannot be sufficiently improved. If the mass percent of the ferriferous oxide nano-particles 320 in the liquid crystal layer 32 is too high, the viscosity of the liquid crystals itself would be affected, and production costs would be increased.

In the present embodiment, the liquid crystal cell may operate as one of a liquid crystal optical grating, a liquid crystal lens, and a liquid crystal prism (discussed below).

The liquid crystal cell may further comprise a photosensitive coupling component (not shown in the figure). The photosensitive coupling component is an integrated circuit integrated on the liquid crystal cell to detect a change in a position of an observer's eyes (by using a gaze tracking technique, for example). Specifically, the photosensitive coupling component may be integrated at a surrounding area of the substrates 33 of the liquid crystal cell. Of course, it may also be integrated at other areas where the detection of the change in the position of human eyes is enabled.

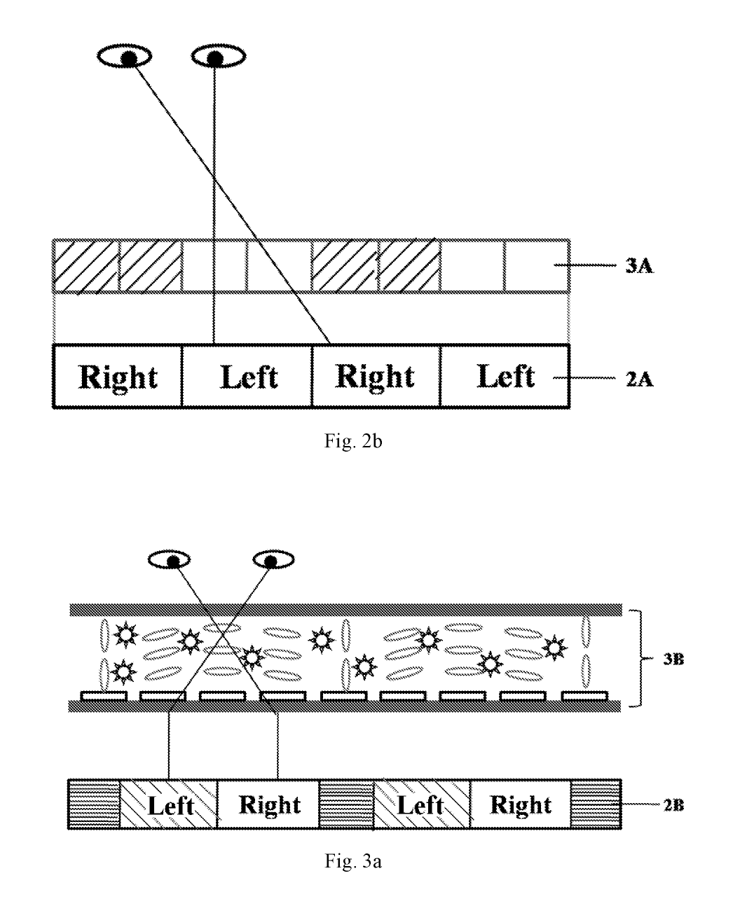

FIG. 2a shows a schematic diagram of a state in which human eyes are looking straight to a screen in an embodiment where the liquid crystal cell is a liquid crystal optical grating, and FIG. 2b shows a schematic diagram of a state in which human eyes are watching a screen from a displaced position in an embodiment where the liquid crystal cell is a liquid crystal optical grating. When the liquid crystal cell operates as a liquid crystal optical grating, a light blocking effect of the liquid crystal layer may be achieved by controlling a voltage applied to liquid crystal electrodes. In an application of an autostereoscopic 3D liquid crystal display device, switching between a 2D mode and a 3D mode may further be achieved by applying a voltage or not. Referring to FIGS. 2a and 2b, a liquid crystal optical grating 3A is provided at a light exiting side of a display panel 2A, and a 3D display effect is realized at different viewing positions through the movement of light-transmissive areas and non-transmissive areas. When eyes are moving, the movement of the light-transmissive areas and non-transmissive areas of the liquid crystal optical grating 3A may be achieved by changing the voltage of the liquid crystal electrodes according to information on the change in the position of the human eyes that is detected by the photosensitive coupling component, such that proper images can still be received by the left eye and the right eye after the movement. As shown in FIG. 2a, when the human eyes are looking straight to the screen, their positions is detected by the photosensitive coupling component. The light-proof areas of the liquid crystal optical grating 3A, which are indicated by the hatched portions in the figure, allow both the left eye and the right eye to receive correct images. When the human eyes are moving to the left, the change in the position of the human eyes is sensed by the photosensitive coupling component, and the applied voltage on the liquid crystal electrodes is changed correspondingly to move the liquid crystal light-proof area to the left, as shown in FIG. 2b, such that correct images are still received by the observer's left eye and right eye.

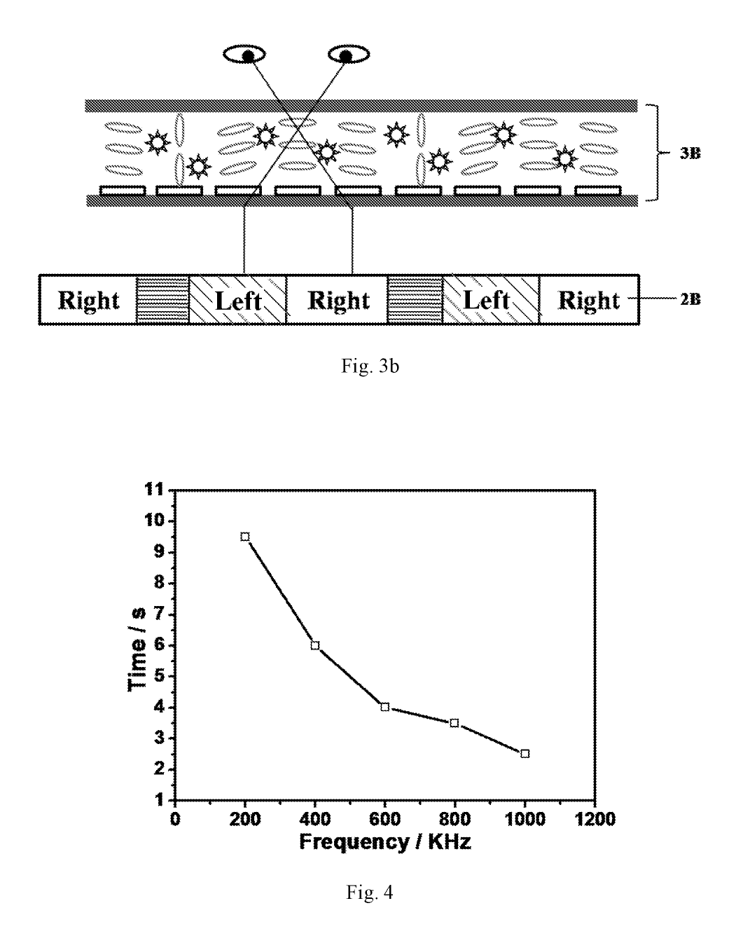

FIG. 3a shows a schematic diagram of a state in which human eyes are watching a screen at a certain angle in an embodiment where the liquid crystal cell is a liquid crystal lens, and FIG. 3b shows a schematic diagram of a state in which human eyes are watching a screen at another angle in an embodiment where the liquid crystal cell is a liquid crystal lens. When the liquid crystal cell operates as a liquid crystal lens, orientations of the liquid crystals are changed by controlling the voltage applied to the liquid crystal electrodes, such that the liquid crystals with different orientations at different positions form a lens that functions as a condenser. In this case, signals for the left eye and the right eye can be delivered from behind a single lens to the human's left eye and right eye respectively through the lens, so as to implement a display with a 3D effect. Referring to FIGS. 3a and 3b, a liquid crystal lens 3B is provided at a light exiting side of a display panel, and a liquid crystal layer of the liquid crystal lens 3B contains ferriferous oxide nano-particles. Upon application of a voltage, the ferriferous oxide nano-particles in the liquid crystal layer of the liquid crystal lens convert electromagnetic energy into heat, such that the temperature of the liquid crystal where the voltage is applied is increased. This results in a reduction of the viscosity coefficient of the liquid crystals, and hence the response time of the liquid crystals. In an application of an autostereoscopic 3D display device, this can increase the response speed of the display device and improve the display effect (by avoiding the occurrence of crosstalk and image dithering, for example).

Further, the liquid crystal cell may also operate as a liquid crystal prism, which is formed by the liquid crystals in the liquid crystal layer forming a prism shape under control of a voltage of the electrodes. Liquid crystals with different orientations at different positions may be allowed to form a lens, by controlling the voltage applied to the liquid crystal electrodes and thus changing the orientations of the liquid crystals. Due to different light refractions at different positions, the left eye and the right eye may be allowed to receive different rays of light (i.e., image information) to achieve a 3D display by the adjustment of the transmissive and non-transmissive conditions for the light.

Generally, the heating effect of the liquid crystal electrode layer that is added with ferriferous oxide nano-particles may be adjusted by changing the content of the ferriferous oxide nano-particles, the frequency and magnitude of the applied voltage, and the like.

FIG. 4 shows a variation curve of the required amount of time for a temperature of a liquid crystal layer added with 1 wt % ferriferous oxide nano-particles increasing by 2° C. versus a frequency of a voltage having a fixed amplitude of 4.0 V. As seen from the figure, the higher the frequency of the applied voltage, the shorter the amount of time required for the temperature of the liquid crystal layer increasing by 2° C. That is, the heating effect of the liquid crystal layer added with ferriferous oxide nano-particles may be adjusted by regulating the frequency of the voltage applied to the liquid crystal electrodes.

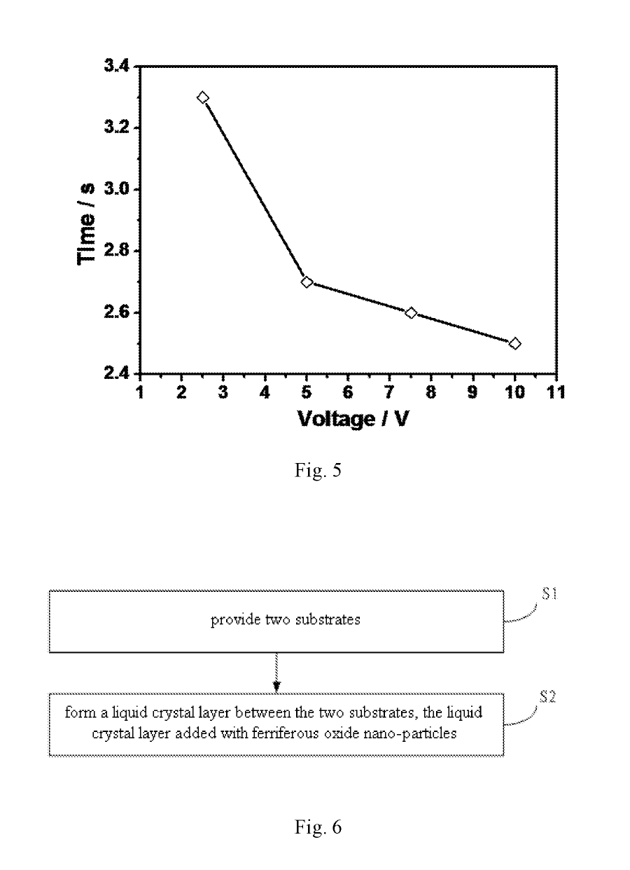

FIG. 5 shows a variation curve of the required amount of time for a temperature of a liquid crystal layer added with 1 wt % ferriferous oxide nano-particles increasing by 2° C. versus a magnitude of an applied voltage having a fixed frequency of 900 KHz. As seen from the figure, the higher the applied voltage, the shorter the amount of time required for the temperature of the liquid crystal layer increasing by 2° C. That is, the heating effect of the liquid crystal layer added with ferriferous oxide nano-particles may be adjusted by regulating the magnitude of the voltage applied to the liquid crystal electrodes.

It is to be noted that the ferriferous oxide nano-particles used in the present embodiment may be modified with oleic acid. Modification refers to form a layer of substance on the surface of a nano-particle through chemical or physical reactions to improve the dispersity of the nano-particle. It is found in practice that the dispersity of the ferriferous oxide nano-particles modified with oleic acid may be effectively increased so that they are not apt to be agglomerated. This allows for a more uniform change in the temperature of the liquid crystals where the voltage is applied, a more uniformly dropped magnitude of the viscosity coefficient of the liquid crystals, and thereby a more evenly reduced response time. As the ferriferous oxide nano-particles modified with oleic acid are not apt to get agglomerated, more such particles may be added. In the present embodiment, the mass percent of the ferriferous oxide nano-particles modified with oleic acid in the liquid crystal layer may be 1-15%.

### Embodiment 1

The present embodiment provides a liquid crystal cell comprising two substrates and a liquid crystal layer disposed between the two substrates. The liquid crystal layer is added with ferriferous oxide nano-particles with a mass percent of 1%.

In this embodiment, the liquid crystal cell operates as a liquid crystal optical grating. When a voltage is applied to the two substrates, the ferriferous oxide nano-particles convert electromagnetic energy into heat, resulting in an increase of the temperature of the liquid crystals where the voltage is applied, a reduction of the viscosity coefficient of the liquid crystals, and hence a decrease of the response time of the liquid crystals. In an application of an autostereoscopic 3D display device, this may boost the response speed of the display device and improve the display effect (for example, by avoiding the occurrence of crosstalk and image dithering).

### Embodiment 2

The present embodiment provides a liquid crystal cell, which comprises two substrates and a liquid crystal layer disposed between the two substrates. The liquid crystal layer is added with ferriferous oxide nano-particles with a mass percent of 5%.

In this embodiment, the liquid crystal cell operates as a liquid crystal lens. Upon application of a voltage, the ferriferous oxide nano-particles convert electromagnetic energy into heat, resulting in an increase of the temperature of the liquid crystals where the voltage is applied, a reduction of the viscosity coefficient of the liquid crystals, and hence a decrease of the response time of the liquid crystals. In an application of an autostereoscopic 3D display device, this may boost the response speed of the display device and improve the display effect (for example, by avoiding the occurrence of crosstalk and image dithering).

### Embodiment 3

The present embodiment provides a liquid crystal cell, which comprises two substrates and a liquid crystal layer disposed between the two substrates. The liquid crystal layer is added with ferriferous oxide nano-particles modified with oleic acid that has a mass percent of 10%.

In this embodiment, the liquid crystal cell operates as a liquid crystal prism. Upon application of a voltage, the ferriferous oxide nano-particles convert electromagnetic energy into heat, resulting in an increase of the temperature of the liquid crystals where the voltage is applied, a reduction of the viscosity coefficient of the liquid crystals, and hence a decrease of the response time of the liquid crystals. In an application of an autostereoscopic 3D display device, this may boost the response speed of the display device and improve the display effect (for example, by avoiding the occurrence of crosstalk and image dithering).

FIG. 6 shows a flow chart of a method for manufacturing a liquid crystal cell in accordance with an embodiment of the present disclosure. As shown in FIG. 6, the method includes the following steps.

At step S1, two substrates are provided.

At step S2, a liquid crystal layer is formed between the two substrates, and the liquid crystal layer is added with ferriferous oxide nano-particles.

In an application of an autostereoscopic 3D display device, the deflection of the liquid crystals in the liquid crystal layer may be controlled to switch between a 2D and a 3D display mode.

In an example, adding ferriferous oxide nano-particles into the liquid crystal layer may comprise adding the ferriferous oxide nano-particles before the liquid crystals are defoamed, and then stirring the ferriferous oxide nano-particles for a uniform distribution among the liquid crystals.

Although individual operations in the accompanying drawings of the method for manufacturing the liquid crystal cell in accordance with embodiments of the present disclosure have been described in a particular order, it should not be construed as these operations are required to be performed necessarily in the particular order as shown or in sequence, nor should it be construed as all of the shown operations should be executed to reach a desired outcome. For example, the ferriferous oxide nano-particles may be added into the liquid crystal layer before or after the liquid crystal layer is formed between two substrates.

In addition, in accordance with another aspect of the present disclosure, a display device is provided which comprises the liquid crystal cell as described above and a display panel. The liquid crystal cell is provided at a light exiting side of the display panel. The display device may be an electronic product such as a mobile phone, a tablet computer, a liquid crystal display, and an e-book.

The foregoing are specific embodiments of the present disclosure. It is appreciated that several modifications and substitutions may be made by those skilled in the art without departing from the technical principle of the present disclosure, and that such modifications and substitutions should also be considered as falling within the scope of the present disclosure.

1. A liquid crystal cell, comprising:
two substrates; and
a liquid crystal layer disposed between the two substrates and provided with ferriferous oxide nano-particles.

2. The liquid crystal cell as recited in claim 1, wherein a mass percent of the ferriferous oxide nano-particles in the liquid crystal layer is 1-10%.

3. The liquid crystal cell as recited in claim 1, wherein the liquid crystal cell is one of a liquid crystal optical grating, a liquid crystal lens, and a liquid crystal prism.

4. The liquid crystal cell as recited in claim 3, further comprising a photosensitive coupling component for detection of a change in a position of an observer's eyes.

5. The liquid crystal cell as recited in claim 1, wherein the ferriferous oxide nano-particles are ferriferous oxide nano-particles modified with oleic acid.

6. The liquid crystal cell as recited in claim 5, wherein a mass percent of the ferriferous oxide nano-particles modified with oleic acid in the liquid crystal layer is 1-15%.

7. A display device comprising a display panel and a liquid crystal cell as recited in claim 1, the liquid crystal cell provided at a light exiting side of the display panel.

8. The display device as recited in claim 7, wherein the display device is operable to work in a 2D display mode or a 3D display mode, wherein the 2D and 3D display modes are switched by controlling a deflection of liquid crystals in the liquid crystal layer of the liquid crystal cell.

9. A method for manufacturing a liquid crystal cell, comprising:
providing two substrates; and
forming a liquid crystal layer between the two substrates, the liquid crystal layer added with ferriferous oxide nano-particles.

10. A display device comprising a display panel and a liquid crystal cell as recited in claim 2, the liquid crystal cell provided at a light exiting side of the display panel.

11. The display device as recited in claim 10, wherein the display device is operable to work in a 2D display mode or a 3D display mode, wherein the 2D and 3D display modes are switched by controlling a deflection of liquid crystals in the liquid crystal layer of the liquid crystal cell.

12. A display device comprising a display panel and a liquid crystal cell as recited in claim 3, the liquid crystal cell provided at a light exiting side of the display panel.

13. The display device as recited in claim 12, wherein the display device is operable to work in a 2D display mode or a 3D display mode, wherein the 2D and 3D display modes are switched by controlling a deflection of liquid crystals in the liquid crystal layer of the liquid crystal cell.

14. A display device comprising a display panel and a liquid crystal cell as recited in claim 4, the liquid crystal cell provided at a light exiting side of the display panel.

15. The display device as recited in claim 14, wherein the display device is operable to work in a 2D display mode or a 3D display mode, wherein the 2D and 3D display modes are switched by controlling a deflection of liquid crystals in the liquid crystal layer of the liquid crystal cell.

16. A display device comprising a display panel and a liquid crystal cell as recited in claim 5, the liquid crystal cell provided at a light exiting side of the display panel.

17. The display device as recited in claim 16, wherein the display device is operable to work in a 2D display mode or a 3D display mode, wherein the 2D and 3D display modes are switched by controlling a deflection of liquid crystals in the liquid crystal layer of the liquid crystal cell.

18. A display device comprising a display panel and a liquid crystal cell as recited in claim 6, the liquid crystal cell provided at a light exiting side of the display panel.

19. The display device as recited in claim 18, wherein the display device is operable to work in a 2D display mode or a 3D display mode, wherein the 2D and 3D display modes are switched by controlling a deflection of liquid crystals in the liquid crystal layer of the liquid crystal cell.
